(19) United States
(12) Patent Application Publication
(10) Pub. No.: US 2013/0207774 A1
(43) Pub. Date: Aug. 15, 2013

(54) Method And Apparatus For Converting Wirelessly Received Relative Coordinates Into Input Value Of Application Program

(71) Applicant: Byoung Hee Ahn, Seoul (KR)

(72) Inventor: Byoung Hee Ahn, Seoul (KR)

(73) Assignee: INNOPIA TECHNOLOGIES, INC., Gyeonggi-do (KR)

(21) Appl. No.: 13/483,438

(22) Filed: May 30, 2012

(30) Foreign Application Priority Data
Feb. 10, 2012 (KR) 10-2012-0013863

(51) Int. Cl. G05B 19/02

(52) U.S. Cl. 340/4.3

(57) ABSTRACT

A method and apparatus for converting relative coordinates into an input value of an application program. An imaging device may convert relative coordinates transmitted from a relative coordinate input device into an input value recognizable by the application program that is executed on the imaging device. The imaging device may generate a specific input value based on a magnitude and a direction indicated by the relative coordinates. The generated input value may be transmitted to the application program, and may increase or decrease a specific value used in the application program.

### CROSS-REFERENCE TO RELATED APPLICATION

The present application claims priority under 35 U.S.C. §119 of Korean Patent Application No. 10-2012-0013863, filed Feb. 10, 2012, the disclosure of which is hereby incorporated herein by reference in its entirety.

### FIELD OF THE INVENTION

The present invention relates generally to a method and apparatus for converting relative coordinates into an input value for an application program, and more particularly, to a method and apparatus that may wirelessly receive relative coordinates from a relative coordinate generator by user manipulation and may generate an input value of an application program based on the relative coordinates.

### BACKGROUND OF THE INVENTION

A set-top box originally used to receive a broadcast signal has continually evolved and advanced to include various multimedia functions. Following this development, a remote control for a set-top box has a relative coordinate input device or gravity sensors and acceleration sensors, as well as a typical keypad.

The relative coordinate input device having the same function as a mouse may be, for example, an optical track pad (OTP) or a touch pad.

In a conventional television (TV) or set-top box, a user generally uses keys of a remote control to control a channel being viewed or a volume level or to play a media file from a storage device, such as, for example, a hard disk or a flash memory, from a desired point. Here, remote control keys are each assigned a function.

From a user perspective, keys having each assigned function are familiar and easy to use, and from a developer perspective, such functions are easy to implement. However, in this case, a remote control may have too many keys. Also, keys may have similar basic characteristics to one another. That is, each function may be to increase or decrease a specific value. For example, the specific value may be a channel number, a volume value, or a playback starting point, that is, a temporal location in the total play time of a media file. In other words, keys related to channel control may increase or decrease a channel number. Keys related to volume control may increase or decrease a volume value. Keys related to playing a media file may increase or decrease a time at which a playback starting point is initiated.

Korean Patent Publication No. 10-2011-0081787, published on Jul. 14, 2011, discloses a multi-functional controller capable of inputting data, such as, for example, characters, numbers, and symbols, and performing functions of a remote control, a mouse, a game pad, and a joystick. The multi-functional controller includes 1) a first manipulating unit to input character, number, or symbol data and to perform a remote control, mouse, game pad or joystick function, 2) a sensor unit to sense a three-dimensional motion of the multi-controller, and 3) a control unit to control a manipulation signal inputted from an input unit and a motion signal inputted from the sensor unit and to convert the manipulation signal and the motion signal into a signal suitable for transmitting to a receiving unit of an external device.

### SUMMARY OF THE INVENTION

An aspect of the present invention provides a method and apparatus for converting relative coordinates generated by a relative coordinate input device into an input value recognizable by an application program.

Another aspect of the present invention also provides a method and apparatus for generating an input value based on a magnitude and a direction indicated by the relative coordinates.

According to an aspect of the present invention, there is provided an imaging device including a receiving unit to wirelessly receive relative coordinates from a relative coordinate input device, and a processor to execute an operating system, an application program running on the operating system, and a conversion module, wherein the conversion module generates an input value recognizable by the application program based on the received relative coordinates and provides the input value to the application program.

The input value may increase or decrease a specific value used in the application program.

The generated input value may be at least one of an input value indicating an input of an up arrow key, an input value indicating an input of a down arrow key, an input value indicating an input of a left arrow key, and an input value indicating an input of a right arrow key.

The conversion module may generate the input value based on a direction indicated by the received relative coordinates.

The relative coordinate input device may be included in a remote control that wirelessly transmits a signal to the imaging device.

The conversion module may be provided with a method for generating the input value based on the received relative coordinates for the application program.

When the application program is capable of processing the received relative coordinates, the conversion module may provide the received relative coordinates to the application program, and when the application program is incapable of processing the received relative coordinates, the conversion module may generate an input value recognizable by the application program based on the received relative coordinates and may provide the input value to the application program.

The conversion module may be provided with information relating to whether the application program is capable of processing the received relative coordinates.

The conversion module may generate a direction and an acceleration of a movement in the direction by using at least one received relative coordinates, may generate at least one input value based on the direction and the acceleration, and may provide the at least one input value to the application program.

According to another aspect of the present invention, there is provided an image output system including an imaging device to output an image, and a relative coordinate input device to wirelessly transmit relative coordinates to the imaging device by the manipulation of a user, the imaging device including a receiving unit to receive the relative coordinates from the relative coordinate input device, and a processor to execute an operating system, an application program running on the operating system, and a conversion module, wherein the conversion module generates an input value recognizable by the application program based on the received relative coordinates and provides the input value to the application program.

According to yet another aspect of the present invention, there is provided a method for operating an imaging device including a processor executing an operating system, the processor executing a conversion module, the processor executing an application program running on the operating system, a receiving unit wirelessly receiving relative coordinates from a relative coordinate input device, the conversion module generating an input value recognizable by the application program based on the received relative coordinates, and the conversion module providing the input value to the application program.

The method may further include the conversion module being provided with a method for generating the input value based on the received relative coordinates for the application program.

The method may further include the conversion module to determine whether the application program is capable of processing the received relative coordinates, and the conversion module providing the received relative coordinates to the application program when the application program is capable of processing the received relative coordinates, wherein the generating of the input value and the providing of the input value to the application program are performed when the application program is capable of processing the received relative coordinates.

The method may further include the conversion module being provided with information relating to whether the application program is capable of processing the received relative coordinates.

According to embodiments of the present invention, inputs using remote control keys with different functions but similar characteristics may be replaced by inputs using a relative coordinate input device embedded in a remote controller, having the same function as a mouse.

According to embodiments of the present invention, this replacement may induce a user to use the input device more actively. Also, a motion of the user at the time of input may be recognized more accurately through at least one relative coordinates, and an intent of the user may be reflected more accurately than inputs from a conventional remote control.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an image output system according to an embodiment of the present invention;

FIG. 2 is a diagram illustrating entities executed by a processor according to an embodiment of the present invention;

FIG. 3 is a flowchart illustrating a method for operating an imaging device according to an embodiment of the present invention;

FIG. 4 is a diagram illustrating an example of a method for generating an input value using relative coordinates; and

FIG. 5 is a diagram illustrating another example of a method for generating an input value using at least one relative coordinates.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

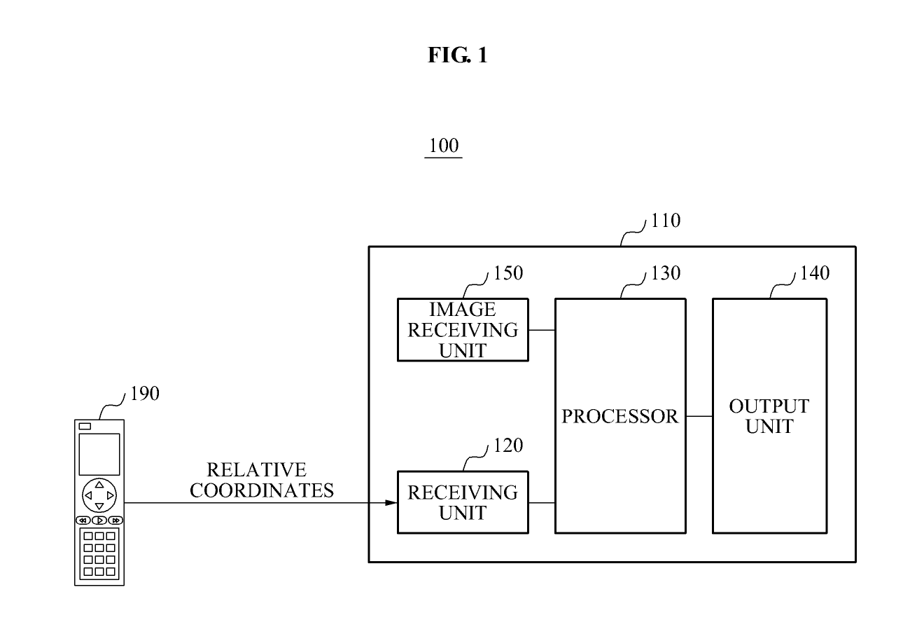

FIG. 1 is a diagram illustrating an image output system 100 according to an embodiment of the present invention.

The image output system 100 may include an imaging device 110 and a relative coordinate input device 190.

The imaging device 110 may output an image.

The relative coordinate input device 190 may generate relative coordinates by user manipulation. For example, the relative coordinate input device 190 may generate relative coordinate indicating a movement of the relative coordinate input device 190 made by a user. The relative coordinate may represent a difference in location of the relative coordinate input device 190 between a first point of time and a second point of time. The second point of time may be a point of time after the lapse of a predetermined time from the first point of time. That is, the relative coordinate input device 190 may periodically generate a relative coordinate.

The relative coordinate input device 190 may be an optical track pad, a touch pad, a mouse, or a track ball. Also, the relative coordinate input device 190 may be a remote controller. That is, the remote controller may generate a relative coordinate by the manipulation of a user, and may provide keys to the user.

The relative coordinate input device 190 may output a relative coordinate and may transmit the relative coordinate to the imaging device 110. The relative coordinate input device 190 may periodically output and transmit a relative coordinate. The imaging device 110 may periodically receive at least one relative coordinate.

The imaging device 110 may include a receiving unit 120 and a processor 130.

The receiving unit 120 may wirelessly receive a relative coordinate from the relative coordinate input device 190. The receiving unit 120 may communicate with the relative coordinate input device 190 using an infrared, radio, or Bluetooth communication technology.

The processor 130 may execute an operating system (OS), an application program, and a conversion module that are executed in the imaging device 110.

The imaging device 110 may further include an output unit 140. The output unit 140 may output a specific TV program, video, or application program by the control of the processor 130. The output unit 140 may be a display device for displaying image information, such as, for example, a liquid crystal display (LCD). Also, the output unit 140 may be a chip or card for outputting image information to an external display device, or a terminal for outputting a signal indicating image information, such as, for example, a high-definition multimedia interface (HDMI) or a display port.

The imaging device 110 may further include an image receiving unit 150. The image receiving unit 150 may receive data of an image outputted by the imaging device 110. The image receiving unit 150 may include at least one of an antenna for receiving ground wave broadcast, cable broadcast or Internet TV broadcast signals, a tuner, a networking chip, and a network interface card (NIC).

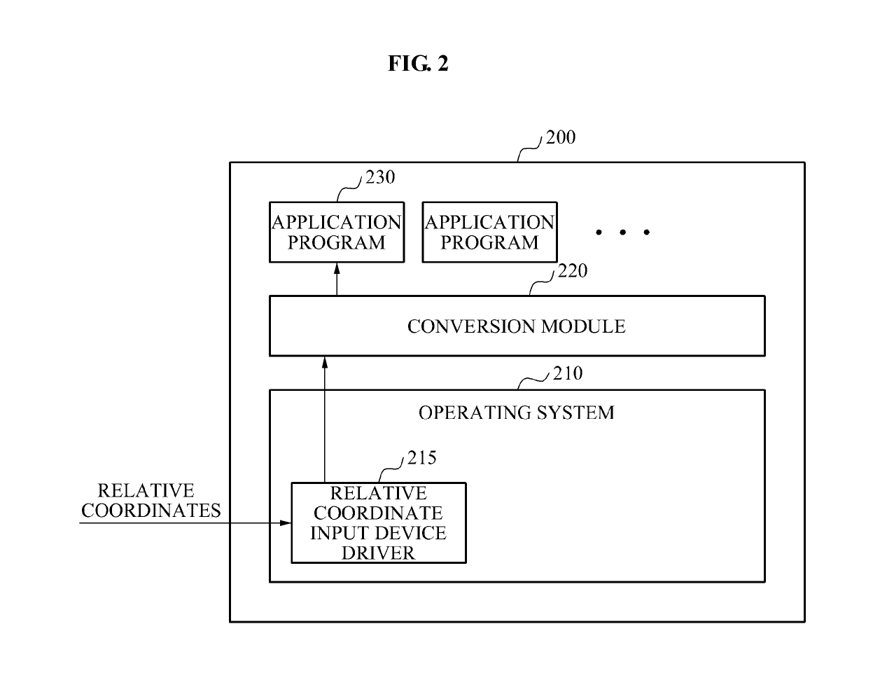

FIG. 2 is a diagram illustrating entities 200 executed by the processor 130 according to an embodiment of the present invention.

The entities 200 may be objects executed by the processor 130.

The processor 130 may execute at least one of an operating system 210, a conversion module 220, and an application program 230.

The application program 230 may run on the operating system 210.

The application program 230 may be a program unable use relative coordinates. For example, the application program 230 can use only an input value generated by pressing a key of a keyboard of the imaging device 110 or a key of the remote control. Hereinafter, the input value may represent a signal transmitted to the application program 230 by the operating system 210 when a key or button of the imaging device 110 or a key of the remote control is pressed.

The conversion module 220 may generate an input value usable by the application program 230 based on the received relative coordinates. Also, the conversion module 220 may provide the generated input value to the application program 230. The conversion module 220 may be one of the application programs that are separate from the operating system 210, or one of the components of the operating system 210.

The operating system 210 may include a relative coordinate input device driver 215. The relative coordinate input device driver 215 may enable the operating system 210 to recognize the relative coordinate input device 190 and may extract relative coordinates from information included in a radio signal transmitted from the relative coordinate input device 190 to the receiving unit 120.

The processor 130 may execute at least one application program 230. For example, the application program 230 may be an application program to which the conversion module 220 provides relative coordinates, among at least one application program executed by the processor 130. Also, the application program 230 may be an application program outputted through the output unit 140 by the control of the processor 130, among at least one application program executed by the processor 130. That is, the conversion module 220 may provide relative coordinates to the application program 230 outputted through the output unit 140.

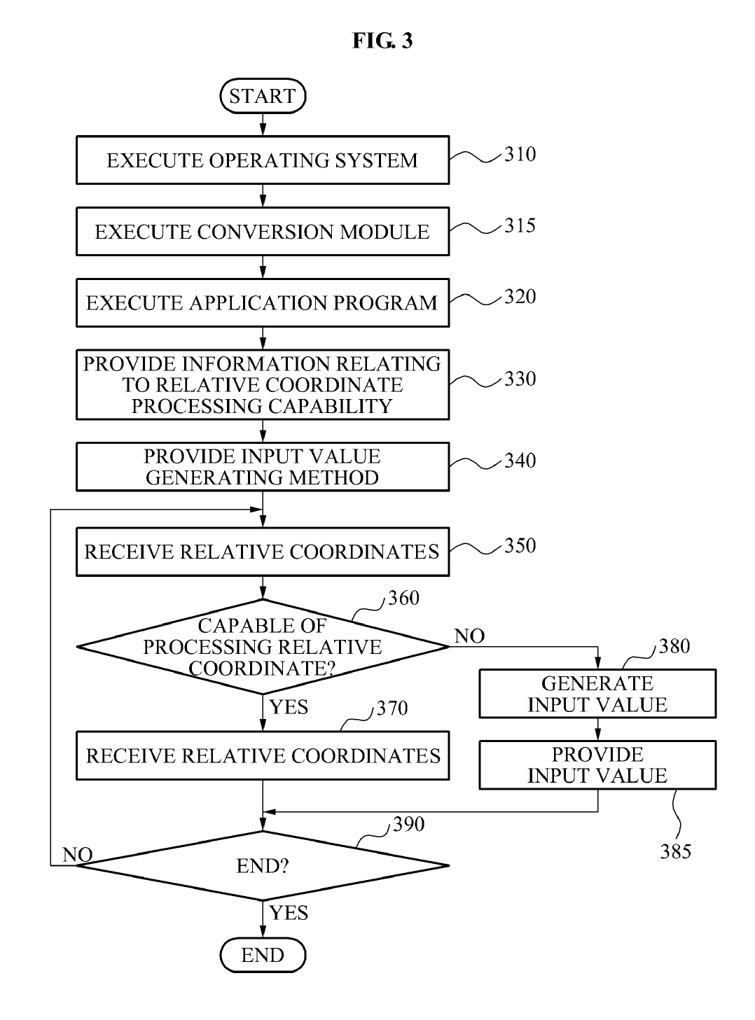

FIG. 3 is a flowchart illustrating a method for operating the imaging device 110 according to an embodiment of the present invention.

In operation 310, the imaging device 110 may boot. The processor 130 may execute the operating system 210.

In operation 315, the processor 130 may execute the conversion module 220. The operating system 210 may process the execution of the conversion module 220, and may register relative coordinates extracted by the relative coordinate input device driver 215 as an object to be transmitted.

In operation 320, the processor 130 may execute the application program 230 running on the operating system 210. The operating system 210 may process the execution of the application program 230.

In operation 330, the conversion module 220 may be provided with information relating to whether the application program 230 can process the received relative coordinates. The specific application program 230 can directly process the relative coordinates as one of the input values. For example, the application program 230 may support an input through a mouse, and may move a cursor in the application program 230 based on the received relative coordinates.

When the application program 230 can directly process the relative coordinates as one of the input values, the relative coordinates may be directly transmitted from the operating system 210 to the application program 230 without passing through the conversion module 220. That is, the relative coordinates may not be converted into an input value by the conversion module 220 and may be transmitted to the application program 230 directly.

The information may be provided to the conversion module 220 based on the settings of a user, the application program 230, or a service provider.

For example, the user of the imaging device 110 may set whether the relative coordinates are to be transmitted directly to the application program 230 for the application program 230. The application program 230 may register the information in a registry of the operating system 210 and the like, and the conversion module 220 may determine whether to transmit the received relative coordinates directly to the application program 230 based on the information registered in the registry and the like. Also, the application program 230 may provide a settings file containing the information to the operating system 210 or the conversion module 220. The service provider may set whether the relative coordinates or a generated input value is to be provided to the application program 230 for the application program 230. These settings may be configured when manufacturing the imaging device 110, and may be configured based on the information transmitted through the image receiving unit 150 during the operation of the imaging device 110.

The application program 230 may transmit the setting information to the conversion module 220 by a communication method, for example, inter-process communication (IPC) and the like. The application program 230 may request the operating system 210 to set a communication channel with the conversion module 220.

When it is registered in the operating system 210 that the relative coordinates are to be transmitted to the application program 230 through the settings or configuration, the operating system 210 may provide the conversion module 220 with information relating to whether the application program 230 can process the received relative coordinates.

The information may be dynamically changed. When a communication channel is set between the application program 230 and the conversion module 220, the operating system 210 may transmit the changed information relating to whether the application program 230 can process the relative coordinates to the conversion module 220.

The application program 230 may become capable of processing the relative coordinates alone, during execution. For example, when the application program 230 provides a cursor on a specific display, the application program 230 may request the conversion module 220 to provide the relative coordinates.

Also, the application program 230 may not use the relative coordinates during execution. For example, when a media file is played over the whole display, the application program 230 may request the conversion module 220 not to provide the relative coordinates or a input value generated by conversion.

Also, the application program 230 may use an input value generated by converting the relative coordinates, during execution. For example, when a menu display of the application program 230 is called, the application program 230 may request the conversion module 220 to provide an input value generated by the conversion module 220.

In operation 340, the conversion module 220 may be provided with a method for generating an input value based on the received relative coordinates for the application program 230. At least one application program 230 executed in the imaging device 110 may use different input values. Accordingly, the conversion module 220 needs to generate an input value based on the received relative coordinates by different methods suitable for the at least one application program 230 and be provided with a specific method for generating the input value.

The method may be provided to the conversion module 220 based on the settings of the user, the application program 230, or the service provider.

For example, the user of the imaging device 110 may set how an input value is to be generated for the application program 230 when certain relative coordinates are input. The application program 230 may set how an input value (that will be transmitted to the application program 230) is to be generated when certain relative coordinates are input. Also, the application program 230 may register a method for generating an input value based on the received relative coordinates in the registry of the operating system 210 and the like, and the conversion module 220 may be provided with the method registered in the registry and the like. Also, the application program 230 may provide a settings file describing the method to the operating system 210 or the conversion module 220. The service provider may set how an input value is to be generated for the application program 230. These settings may be implemented when manufacturing the imaging device 110, and may be implemented by information transmitted through the image receiving unit 150 during the operation of the imaging device 110.

When a specific method for generating an input value based on the received relative coordinates is registered in the operating system 210 through the settings or configuration, the operating system 210 may provide the method for generating an input value based on the received relative coordinates to the conversion module 220.

The application program 230 may transmit the method to the conversion module 220 by a communication method, for example, inter-process communication (IPC) and the like. A connection for this communication may be set in operation 330. A specific method for generating an input value may be dynamically changed during execution of the application program 230, and the application program 230 may transmit the changed method to the conversion module 220.

In operation 350, the receiving unit 120 may wirelessly receive the relative coordinates from the relative coordinate input device 190. The receiving unit 120 may receive a signal representing the relative coordinates from the relative coordinate input device 190, and the operating system 210 or the relative coordinate input device driver 215 may extract the relative coordinates from the received signal. Also, the operating system 210 or the relative coordinate input device driver 215 may provide the conversion module 220 with the extracted relative coordinates.

The relative coordinate input device 190 may be included in a remote control that wirelessly transmits a signal to the imaging device 110. That is, the relative coordinate input device 19 may be a portion of the remote control.

In operation 360, the conversion module 220 may determine whether the application program 230 can process the received relative coordinates. The conversion module 220 may make this determination based on the information relating to whether the application program 230 can process the received relative coordinates as described in operation 330. When the application program 230 can process the received relative coordinates, operation 370 may be performed. When the application program 230 is unable to process the received relative coordinates, operations 380 and 385 may be performed.

When the application program 230 can process the received relative coordinates, in operation 370, the conversion module 220 may provide the received relative coordinates to the application program 230.

When the application program 230 cannot process the received relative coordinates, in operation 380, the conversion module 220 may generate an input value recognizable by the application program 230 based on the received relative coordinates. The conversion module 220 may convert the received relative coordinates into an input value. Here, the input value may increase or decrease a specific value used in the application program 230.

In operation 385, the conversion module 220 may provide the generated input value to the application program 230.

In operation 390, the processor 130 may determine whether the operating system 210, the conversion module 220, or the application program 230 has ended. When the operations of the operating system 210, the conversion module 220, or the application program 230 have ended, the processor 130 may end operations 310 to 390. When the operations of the operating system 210, the conversion module 220, or the application program 230 are continuing, the processor 130 may repeat operation 350.

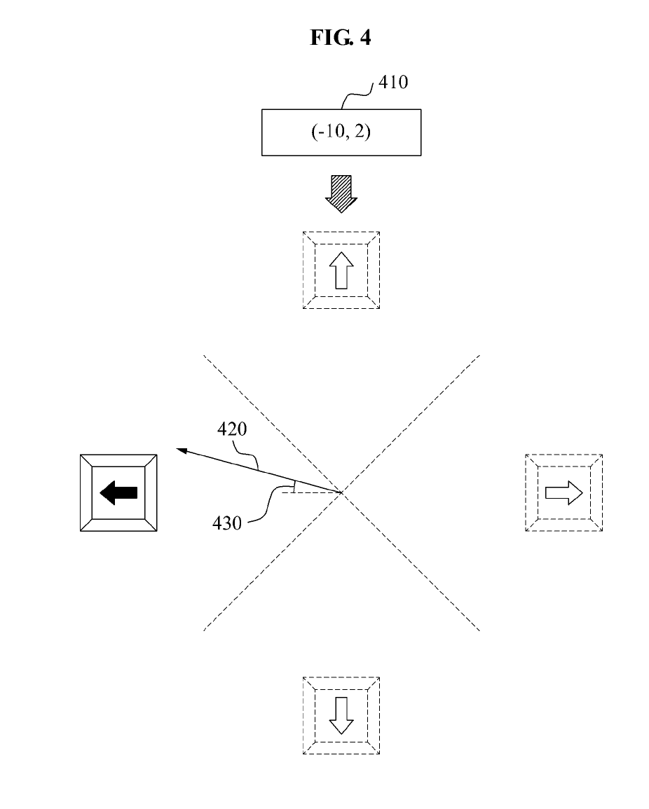

FIG. 4 is a diagram illustrating an example of a method for generating an input value using relative coordinates.

As described with reference to FIG. 3, in operation 380 the conversion module 220 may generate an input value to be provided to the application program based on relative coordinates 410.

For example, the conversion module 220 may calculate a magnitude and a direction (or an angle 430) indicated by the relative coordinates 410 based on the relative coordinates 410. The length of an arrow 420 may represent a magnitude. In FIG. 4, among arrow keys of four directions, an arrow key corresponding to the range to which the direction indicated by the relative coordinates 410 belongs may be selected. When the selected arrow key is pressed on a remote control or a keyboard, an input value may be generated.

Accordingly, the generated input value may be at least one of an input value indicating an input of an up arrow key, an input value indicating an input of a down arrow key, an input value indicating an input of a left arrow key, and an input value indicating an input of a right arrow key. The conversion module 220 may generate an input value indicating an input of an up arrow key, a down arrow key, a left arrow key, or a right arrow key, for example, a key press or release, based on the relative coordinates 410.

In FIG. 4, the relative coordinates 410 indicate a left upward movement. For example, when the relative coordinate input device 190 is a mouse, the user may have moved the mouse to a left upward direction. When the relative coordinate input device 190 is a track ball, the user may have rolled the track ball in a left upward direction. According to the relative coordinates 410, a left movement is greater than an up movement. Accordingly, the conversion module 220, by using the relative coordinates 410, may generate an input value indicating that a left arrow key has been pressed.

As described above, the conversion module 220 may generate an input value based on at least one of a magnitude and a direction indicated by the relative coordinates 410. The conversion module 220 may convert a specific range of magnitude or direction indicated by the relative coordinates 410 into a specific input value based on the method for generating an input value based on the received relative coordinates, as described in operation 340.

The conversion module 220 may generate at least one input value based on at least one of a magnitude and a direction indicated by the relative coordinates 410. The conversion module 220 may generate at least one input value corresponding to a left or right direction indicated by the relative coordinates 410 and at least one input value corresponding to an up or down direction indicated by the relative coordinates 410 by comparing the magnitude of the left or right direction with the magnitude of the up or down direction. For example, as illustrated in FIG. 4, the magnitude of a left movement is five times greater than the magnitude of an up movement. Accordingly, the conversion module 220 may generate a first input value indicating that a left arrow key is pressed five times and a second input value indicating that an up arrow key is pressed once.

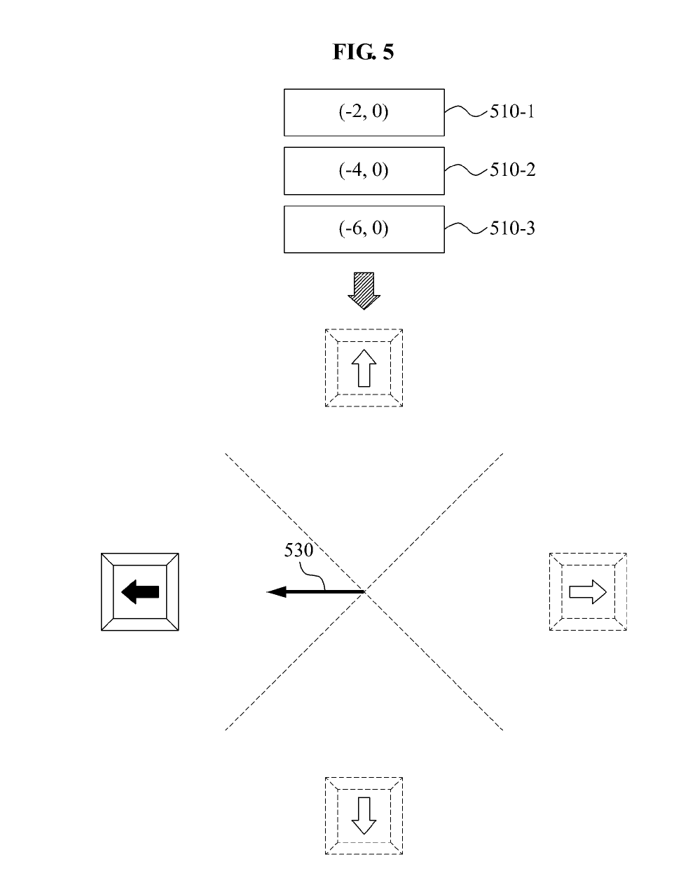

FIG. 5 is a diagram illustrating another example of a method for generating an input value using at least one relative coordinates.

As described with reference to FIG. 3, in operation 380 the conversion module 220 may generate an input value to be provided to the application program 230 based on at least one received relative coordinates. The at least one received relative coordinates may be periodically transmitted to the conversion module 220 on an individual basis.

In FIG. 5, as the at least one received relative coordinates, first relative coordinates 510-1, second relative coordinates 510-2, and third relative coordinates 510-3 are illustrated. The conversion module 220 may generate a direction and an acceleration of a movement in the direction indicated by the at least one relative coordinates, based on the at least one received relative coordinates. In FIG. 5, the at least one received relative coordinates indicates a left direction and an acceleration of a movement in the left direction. The length of an arrow 520 may represent a magnitude of an acceleration, and the direction indicated by the arrow 520 may correspond to a direction indicated by the at least one received relative coordinates.

The conversion module 220 may generate at least one input value based on the direction and the acceleration. For example, the conversion module 220 may generate an input value corresponding to the direction the number of times in proportion to the acceleration of the movement in the direction.

As described with reference to FIG. 3. in operation 380 the conversion module 220 may provide the at least one generated input value to the application program 230.

In this instance, the technical disclosures described with reference to FIGS. 1 to 4 may be applied to FIG. 5, and thus, a repeated description is omitted for conciseness.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

WHAT IS CLAIMED IS:

What is claimed is:

1. An imaging device comprising:
a receiving unit to wirelessly receive a relative coordinates from a relative coordinate input device; and
a processor to execute an operating system, an application program running on the operating system, and a conversion module,
wherein the conversion module generates an input value recognizable by the application program based on the received relative coordinates and provides the input value to the application program.

2. The imaging device of claim 1, wherein the input value increases or decreases a specific value used in the application program.

3. The imaging device of claim 1, wherein the generated input value is at least one of an input value indicating an input of an up arrow key, an input value indicating an input of a down arrow key, an input value indicating an input of a left arrow key, and an input value indicating an input of a right arrow key.

4. The imaging device of claim 3, wherein the conversion module generates the input value based on a direction indicated by the received relative coordinates.

5. The imaging device of claim 1, wherein the relative coordinate input device is included in a remote control that wirelessly transmits a signal to the imaging device.

6. The imaging device of claim 1, wherein the conversion module is provided with a method for generating the input value based on the received relative coordinates for the application program.

7. The imaging device of claim 1, wherein when the application program is capable of processing the received relative coordinates, the conversion module provides the received relative coordinates to the application program, and when the application program is unable to process the received relative coordinates, the conversion module generates an input value recognizable by the application program based on the received relative coordinates and provides the input value to the application program.

8. The imaging device of claim 7, wherein the conversion module is provided with information relating to whether the application program is capable of processing the received relative coordinates.

9. The imaging device of claim 1, wherein the conversion module generates a direction and an acceleration of a movement in the direction by using at least one received relative coordinates, generates at least one input value based on the direction and the acceleration, and provides the at least one input value to the application program.

10. An image output system comprising:
an imaging device to output an image; and
a relative coordinate input device to wirelessly transmit relative coordinates to the imaging device by the manipulation of a user,
the imaging device including:
a receiving unit to receive the relative coordinates from the relative coordinate input device; and
a processor to execute an operating system, an application program running on the operating system, and a conversion module,
wherein the conversion module generates an input value recognizable by the application program based on the received relative coordinates and provides the input value to the application program.

11. A method for operating an imaging device, the method comprising:
a processor executing an operating system;
the processor executing a conversion module;
the processor executing an application program running on the operating system;
a receiving unit wirelessly receiving relative coordinates from a relative coordinate input device;
the conversion module generating an input value recognizable by the application program based on the received relative coordinates; and
the conversion module providing the input value to the application program.

12. The method of claim 11, wherein the input value increases or decreases a specific value used in the application program.

13. The method of claim 11, wherein the generated input value is at least one of an input value indicating an input of an up arrow key, an input value indicating an input of a down arrow key, an input value indicating an input of a left arrow key, and an input value indicating an input of a right arrow key.

14. The method of claim 13, wherein the conversion module generates the input value based on a direction indicated by the received relative coordinates.

15. The method of claim 11, wherein the relative coordinate input device is included in a remote control that wirelessly transmits a signal to the imaging device.

16. The method of claim 11, further comprising:
the conversion module being provided with a method for generating the input value based on the received relative coordinates for the application program.

17. The method of claim 11, further comprising:
the conversion module determining whether the application program is capable of processing the received relative coordinates; and
the conversion module providing the received relative coordinates to the application program when the application program is capable of processing the received relative coordinates,
wherein the generating of the input value and the providing of the input value to the application program are performed when the application program is capable of processing the received relative coordinates.

18. The method of claim 17, further comprising:
the conversion module receiving information relating to whether the application program is capable of processing the received relative coordinates.

19. The method of claim 11, wherein the conversion module generates a direction and an acceleration of a movement in the direction by using at least one received relative coordinates, generates at least one input value based on the direction and the acceleration, and provides the at least one input value to the application program.

20. A non-transitory computer-readable record medium comprising a program for executing the method of claim 11.
